(19) United States
(12) Patent Application Publication
(10) Pub. No.: US 2026/0108061 A1
(43) Pub. Date: Apr. 23, 2026

(54) Composite Handles and Knobs

(71) Applicant: Current, Inc., East Haven, CT (US)

(72) Inventors: Steven Prinz, JR., Guilford, CT (US); Steven Richard Prinz, SR., Guilford, CT (US); Troy Prinz, Guilford, CT (US)

(21) Appl. No.: 18/921,597

(22) Filed: Oct. 21, 2024

(51) Int. Cl. A47B 95/02; B32B 1/00; B32B 21/04; E05B 1/00

(52) U.S. Cl. CPC A47B 95/02; B32B 1/00; B32B 21/042; E05B 1/0015; A47B 2095/024; A47B 2095/028; B32B 2307/404; B32B 2307/7376; B32B 2479/00

(57) ABSTRACT

A handle is provided with a body made of a material which is a multi ply resin impregnated wood, at least two of the plys are dyed different colors and are arranged in a pattern within the body, the body has a proximal end and a distal end, the distal end includes a base. An insert is positioned in a blind hole of the base and the insert is made of a second material different from the material and a distal most portion of the insert is positioned flush or below the base. The insert includes a female threaded portion having a central axis and the insert is mounted in the material and the proximal end of the body excludes one or more through holes. The body is symmetrical about the axis and includes one or more sections which include a circular cross section taken across the axis and a side profile of the body varies in width measured through the axis between the proximal and distal ends. All of the plys are arranged substantially parallel to the axis such that a side surface of the body includes portions where the plys are seen substantially vertically arranged along the axis and another side where plys create a variable shaped pattern.

### FIELD OF THE INVENTION

The present disclosure relates to handles and drawer pulls, for example, handles and drawer pulls for doors and cabinets.

### BACKGROUND

Knobs and handles for cabinets and drawers are traditionally made of metal or include visible metal components that allow for attaching the handles to the drawers. Metal is traditionally more challenging and more expensive to work with than wood. Furthermore, variations in colors in metal are more challenging to obtain.

Some knobs and handles have been made in wood, but these are usually turned parts from a block of wood which result in grain tearing during turning which requires sanding to provide a smooth surface. Furthermore, the wood handle needs to be attached to the cabinet/drawer/door and usually this is done by using a coarse thread wood screw threaded directly into the wood. Direct threading into the wood can often result in tearing or deforming of the threads which can make the knob/handle loose.

Furthermore, some examples of wood based knobs/handles that have been envisioned require that the metal fastener be visible from the exterior, such as attaching into a through hole of the handle/knob visible from the exterior.

Thus, it is desirable to provide a handle/knob to overcome these and other disadvantages.

### SUMMARY

The following presents a simplified summary of the claimed subject matter in order to provide a basic understanding of some aspects of the claimed subject matter. This summary is not an extensive overview of the claimed subject matter. It is intended to neither identify key or critical elements of the claimed subject matter nor delineate the scope of the claimed subject matter. Its sole purpose is to present some concepts of the claimed subject matter in a simplified form as a prelude to the more detailed description that is presented later.

It is an object of the present invention to provide a composite wood handle/knob that is aesthetically pleasing while allowing for secure mounting without (or with minimal) visible metal parts.

It is further desirable to provide a composite wood handle that is made of a durable material that is easier to work with than metal but at the same time durable and long lasting.

It is further desirable to provide for mounting a wood handle with machine screw style threads.

These and other objects are achieved by providing a handle including a body made of a material which is a multi ply resin impregnated pressure and heat cured wood. In certain aspects, at least two of the plys are dyed different colors and are arranged in a pattern within the body. The body has a proximal end and a distal end, the distal end comprising a base. An insert is positioned in a blind hole of the base and the insert is made of a second material different from the material and a distal most portion of the insert is positioned flush or below the base. The insert includes a female threaded portion having a central axis and the insert is mounted in the material.

In certain aspects, the body is symmetrical about the axis. In other aspects at least some of the plys are arranged substantially parallel to the axis. In other aspects all of the plys are arranged substantially parallel to the axis such that a side surface of the body includes portions where the plys are seen vertically arranged along the axis and another side where plys create a variable shaped pattern. In other aspects at least three of the plys are dyed different colors and are arranged in the body in a repeating pattern. In other aspects the insert comprises only a single insert and the insert includes exterior threads which interact with female threads in the hole of the body, wherein the threads are in the material. In still other aspects an adhesive secures the insert to the hole in the body. In still other aspects, the base includes a first section and two side sections, each side section including one of two bases and the two side sections are spaced apart and connected to the first section, each base comprising the insert positioned in the hole of the base, the insert being metallic and the distal most portion of each insert is positioned flush or below the base, each insert comprising the female threaded portion and each having a central axis and the insert is mounted in the material, the central axis of a first one of the two side sections is substantially parallel the central axis of a second one of the two side sections. In other aspects, the plys of the two side sections are arranged substantially parallel the respective central axis of that side section and plys of the first section are arranged transverse the plys of the two side sections. In still other aspects the plys of the first section are substantially perpendicular the plys of the two side sections. In yet other aspects a proximal surface comprises portions of at least two of the plys which are at least three times wider than a thickness of the plys such that the proximal surface varies in color based on which of the plys is visible. In further aspects the plys of the two side sections and the plys of the first section are arranged substantially parallel to the axis. In still other aspects wherein the plys are arranged longitudinally along the first section. In yet other aspects a side surface of the first section is positioned on either side of a proximal surface of the first section and the side surface comprises portions of at least two of the plys which are at least three times wider than a thickness of the plys such that the side surface varies in color longitudinally based on which of the plys is visible.

Yet other objects of the invention are achieved by providing a handle including a body comprising a material which is a multi ply resin impregnated wood. In certain aspects, at least two of the plys are dyed different colors and are arranged in a pattern within the body. The body has a proximal end and a distal end, the distal end includes a base. The insert is positioned in a blind hole of the base and the insert is made of a second material different from the material and a distal most portion of the insert is positioned flush or below the base. The insert includes a female threaded portion having a central axis and the insert is mounted in the material and the proximal end of the body excludes one or more through holes. The body is symmetrical about the axis and includes one or more sections which include a circular cross section taken across the axis and a side profile of the body varies in width measured through the axis between the proximal and distal ends. Furthermore, all of the plys are arranged substantially parallel to the axis such that a side surface of the body includes portions where the plys are seen substantially vertically arranged along the axis and another side where plys create a variable shaped pattern. The handle is configured to be mounted with the base flush against another part such that the insert is not visible.

In certain aspects the insert includes only a single insert and the insert includes exterior threads which interact with female threads in the hole of the body, wherein the threads are in the material. In certain aspects, the insert is metallic. In other aspects the body is symmetrical about an axis of the blind hole. In further aspects at least three of the plys are dyed different colors and are arranged in a repeating pattern and the plys are approximately ⅛ inches thick or less. In other aspects the handle is configured to be mounted such that only the material and any finishes thereon are visible.

Other objects of the invention and its particular features and advantages will become more apparent from consideration of the following drawings and accompanying detailed description.

### BRIEF DESCRIPTION OF THE DRAWINGS

FIG. 1 a side perspective exploded view of a handle according to aspects of the present invention.

FIG. 2A is a side perspective exploded view of a handle according to aspects of the present invention.

FIG. 2B is a side perspective view of the handle of FIG. 2A.

FIG. 3 is a front view of the handle of FIG. 2B.

FIG. 4 is a top view of the handle of FIG. 2B.

FIG. 5 is a bottom view of the handle of FIG. 2B.

FIG. 6A is an exploded perspective view of a handle according to aspects of the present invention.

FIG. 6B is a perspective view of a handle of FIG. 6A.

FIG. 7 is an exploded perspective view of a variation of the handle of FIG. 6A-B.

FIG. 8 is an exploded perspective view of another variation of the handle of FIG. 6A-B.

FIG. 9 is a side view of a handle according to additional aspects of the present invention.

FIG. 10 is a flow chart of an exemplary manufacturing method for the handles disclosed herein.

### DETAILED DESCRIPTION

Reference will now be made in detail to specific embodiments illustrated in the accompanying drawings. In the following detailed description, numerous specific details are set forth to provide a thorough understanding. However, it will be apparent to one of ordinary skill in the art that embodiments may be practiced without these specific details. In other instances, known methods, procedures and/or components have not been described in detail so as not to unnecessarily obscure aspects of the embodiments.

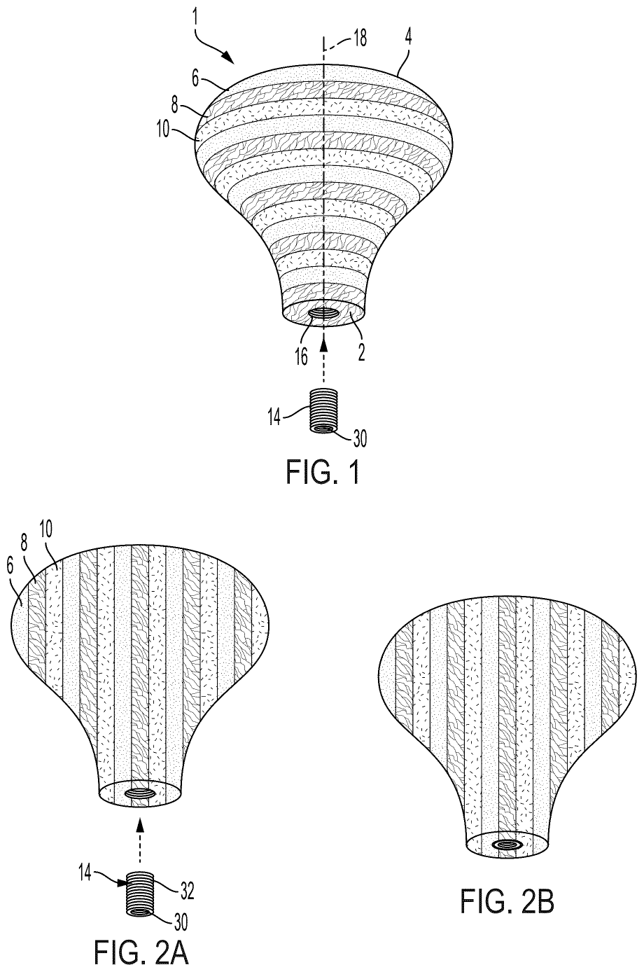

Referring to FIG. 1 an knob 1 is shown with a proximal end 4 and a distal end 2. The knob is made from a composite wood material which is formed from several plys. Each ply 6, 8, 10, is preferably of a different dyed color (e.g. wood dye, stain etc). The plys are preferably arranged in a pattern with the material and in the embodiment shown, the handle 1 is symmetrical about axis 18 and the plys are arranged substantially perpendicular. In reference to the term “substantially” or “approximately” a person of skill in the art will appreciate that since natural materials and plys are used along with resins and pressure forming to make the material, there may be imperfections and wavyness either of the layer or surface thereof or thickness of resin and variations in the material that do not create perfectly straight or perfectly parallel or perpendicular results or perfectly uniform thicknesses, but these are ordinary variations in manufacturing.

The distal end 2 or base of the handle/knob is provided with a hole 16 therein. A threaded insert of a different material than the composite wood is provided. Preferably this insert may be made of metal, however various polymer based materials or polymer composites or other materials may be used. The insert includes female threads 30 to enable securing to fasteners. Preferably these threads are of the machine or fine thread variant as opposed to the more coarse or “wood” screw style threads.

In preferred aspects, the hole 16 is a blind hole that does not go all the way though to the proximal side 4 such that the attachment insert 14 is not visible when the knob/handle 1 is mounted to a planar surface such as a door or drawer, for example on a cabinet. Therefore, the insert 14 is flush with the base surface 2 or below that surface.

The insert includes female threads on the inside of a machine screw thread or more fine thread variation which a person of skill in the art would understand is contrasted with wood screw threads which tend to be more coarse. The exterior surface of the insert may also include threads. These exterior or male threads may be of a more coarse variety or may be machine/fine threads. The drilled hole 16 may also be tapped with corresponding threads. The insert 14 may also be secured in the hole 16 with an adhesive.

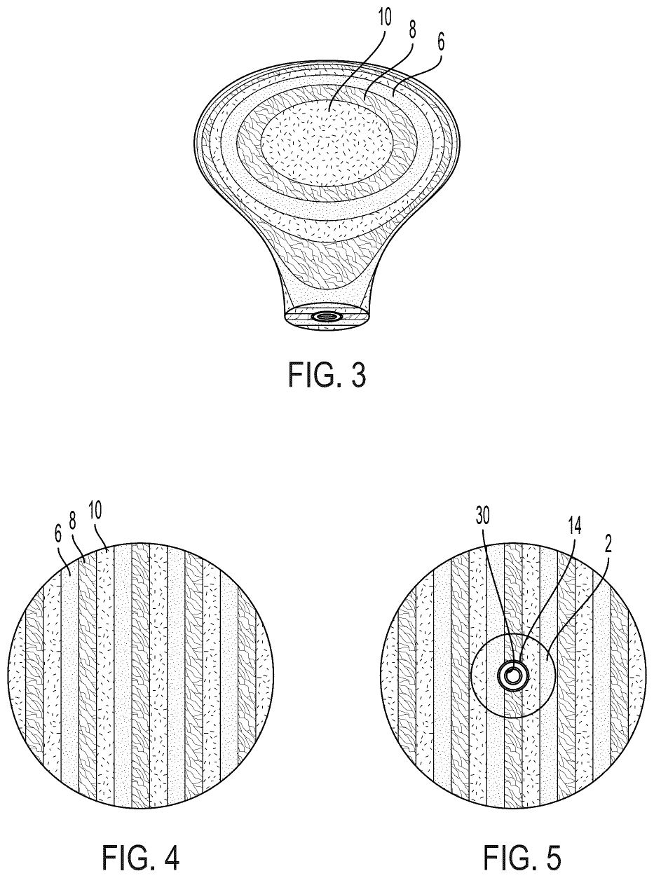

FIG. 2A-B, and 3-6 show a handle similar to that of FIG. 1 but with the wood plys arranged parallel to the axis 18. From the side view of FIG. 2A/B the plys appear vertically arranged, but the front view in FIG. 3 shows the variations of the ply shape due to how the handle is cut/turned in that curved and varied lines 24 are created in that the colors of plys 10, 8 and 6 are different, thus as the turning cuts through one ply to the other, the color changes. This provides an aesthetically different and unique look for a knob, especially one with a blind hole for attaching that does not require visible metal parts or visible fasteners, particularly without visible fasteners or fastener plugs at the proximal end 4. For example a through hole that is plugged at the proximal end would not be a blind hole. Thus, the hole 16 has a depth that is less than the distance between proximal and distal ends of the knob/handle. The insert 14 may be a helicoil insert which self resists backing out, or the hole in the base may be threaded 34 and the insert may be both theaded and glued in the hole with an adhesive. The insert 14 is made of a different material than the body of the handle (e.g. other than the composite resin impregnated wood), for example a nylon, metal, glass reinforced plastics or other materials may be used.

As seen from the top view in FIG. 4, the knob is provided without plugs or holes in the proximal end such that fasteners to secure the knob are not visible. As seen in FIG. 5, the insert 14 includes female threads and is embedded in the knob such that when the knob is attached to a door/drawer, the insert 14 is not visible.

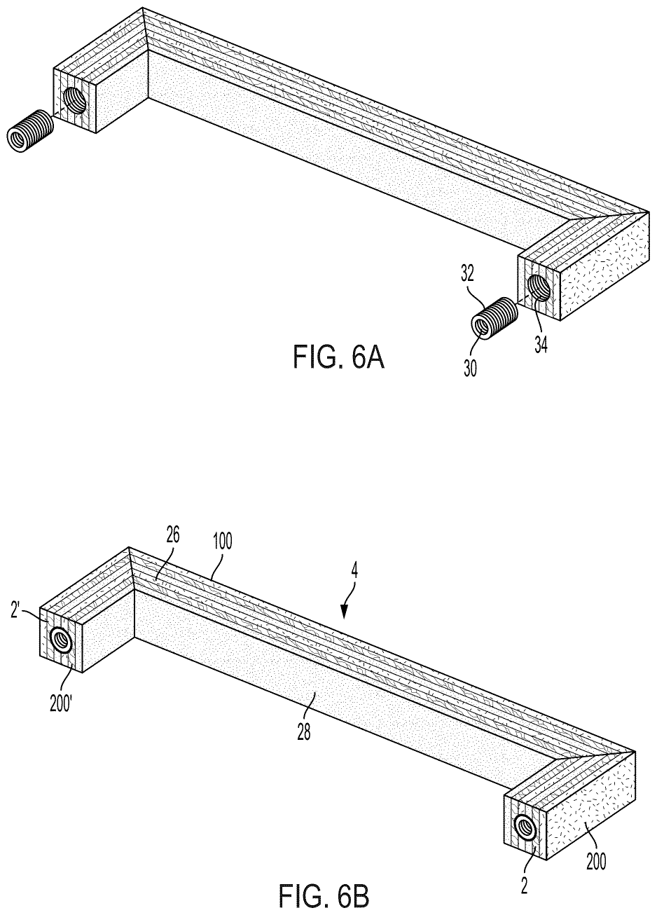

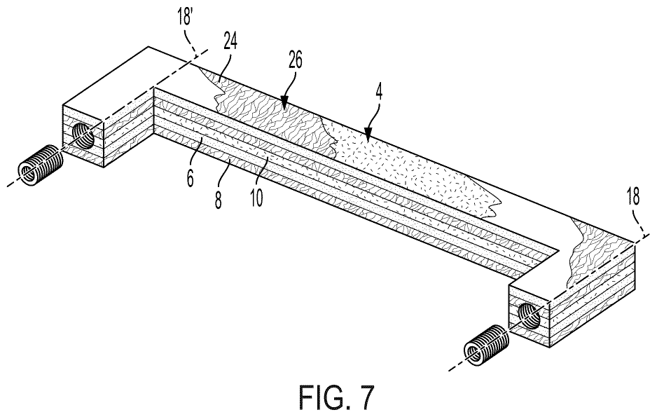

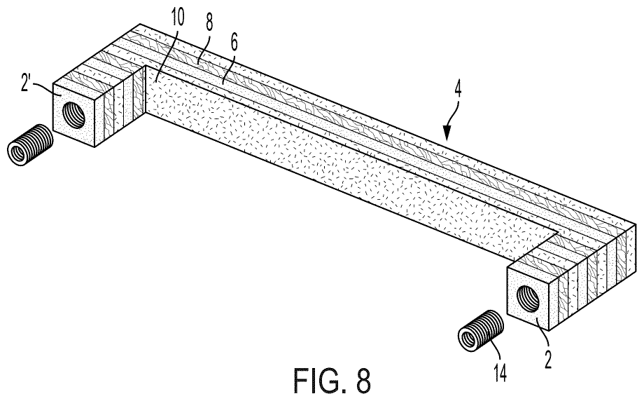

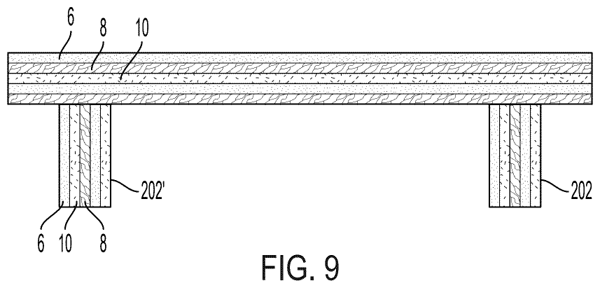

FIG. 6A and B show another variation of a handle made from the wood composite material used in the prior handle variation. In this variation, two side sections 200/200′ are provided, each with holes 34 and corresponding inserts 14. In the variation shown in FIG. 6A and B, the plys on the side sections 200/200′ are arranged substantially parallel to the axis of the insert hole. The plys of the middle section 100 are arranged longitudinaly or transverse or substantially perpendicular to the side sections 200/200′. The ends of the side sections 200/200′ and the middle section 100 meet at an approximately 45 degree miter cut where they are attached together, for example with an adhesive. In the variation shown in FIG. 7, the plys are arranged in planes parallel to both axes 18/18′ of the side sections or extending across the handle longitudinally such that the plys are continuous in the corners/meeting areas of the side sections and middle sections. Namely, the plys are continuous between the side sections and the middle section. FIG. 8 shows an alternate arrangement of the plys, generally perpendicular or transverse to the axes in both the side sections and middle section. FIG. 9 shows another variation where the side sections 202′/202 are offset from the ends of the middle and the plys of the sides 202/202′ are arranged substantially parallel or longitudinally with the side section 202/202′ and the plys of the middle section are arranged transverse the axis of the hole for the insert (not shown) and generally parallel or longitudinally with the middle.

Referring to FIG. 7, in some examples the plys are arranged at an angle or are cut close to the interface between layers such that the handle cut causes layer/grain lines 24 to be visible between layers on the side surface 26. Thus, more than one layer may show on some surfaces of the handle across the width of the handle on the corresponding surface.

In each of the variations shown, the base is configured to mount flush to another part such as a flat cabinet or drawer such that from the front side, no fasteners or materials other than the composite wood material are visible. Thus, metal or materials other than the composite wood and any finishes thereon are not visible from the outside when the handle is mounted, however, the inside screw that secures through the door/drawer and the hole therein into the insert would be visible.

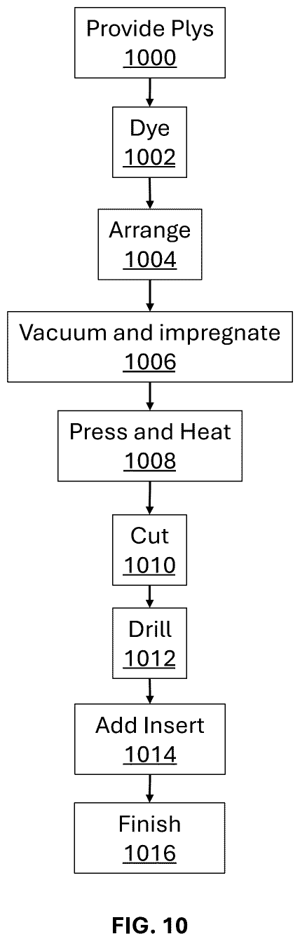

Referring to FIG. 10, an example method of manufacture is shown. The wood plys are provided 1000 and are dyed 1002 in the various colors needed. Preferably, the plys are ⅛ inches thick or less, more preferably approximately 1/16 of an inch thick and most preferably a light colored or “white” wood such as birch. Once dyed 1002, the plys are arranged 1004, preferably in a repeating pattern, e.g. red, green, blue, red, green blue if three colors are used. These are but some examples and more or fewer colors can be used. The pattern may not be exactly repeating in a cyclical 1,2,3,1,2,3 pattern. For example red, green, red, green, blue, red, green, red, green, blue or a variety of other repeating patterns may be used or non-repeating patterns may also be used. The resin is also arranged between the plys and the layers are placed under vacuum 1006 to impregnate the wood. The vacuum ‘bursts’ the grain structure of the wood, allowing the resin to impregnate the layers. These layers are pressed and heated 1008 to cure the resin to create the composite wood material. This material is then cut to shape 1010. The hole for he insert is drilled 1012 partially but not all the way though the cut shape and the insert is added 1014. The knob is finished by e.g. sanding and/or a transparent/translucent finish such as a clear coat. The finishing process may also take place in whole or in part during cutting 1010. The cutting 1010 may include use of a variety of tools, for example of a CNC router, saws or, for example turning with a lathe (e.g. CNC lathe).

There are no limitations in terms of the particular embodiments described in this application, which are intended as illustrations of various aspects only. Many modifications and variations can be made without departing from its spirit and scope, as will be apparent to those skilled in the art. Functionally equivalent methods and apparatuses, in addition to those enumerated herein, will be apparent to those skilled in the art from the foregoing descriptions. Such modifications and variations are intended to fall within the scope of the appended claims. Only the terms of the appended claims are intended to be limiting, along with the full scope of equivalents to which such claims are entitled. It is also to be understood that the terminology used herein, e.g., “and”, “or”, “including”, “at least” as well as the use of plural or singular forms, etc., is for the purpose of describing examples of embodiments and is not intended to be limiting.

What is claimed is:

1. A handle comprising:
a body comprising a material which is a multi ply resin impregnated pressure and heat cured wood, the body has a proximal end and a distal end, the distal end comprising a base;
an insert positioned in a blind hole of the base, wherein the insert is made of a second material different from the material and a distal most portion of the insert is positioned flush or below the base, the insert comprising a female threaded portion having a central axis and the insert is mounted in the material.

2. The handle of claim 1 wherein the body is symmetrical about the axis.

3. The handle of claim 1 wherein at least some of the plys are arranged substantially parallel to the axis.

4. The handle of claim 2 wherein all of the plys are arranged substantially parallel to the axis such that a side surface of the body includes portions where the plys are seen vertically arranged along the axis and another side where plys create a variable shaped pattern.

5. The handle of claim 4 wherein at least at least two of the plys are dyed different colors and are arranged in a pattern within the body.

6. The handle of claim 4 wherein the insert comprises only a single insert and the insert includes exterior threads which interact with female threads in the hole of the body, wherein the threads are in the material.

7. The handle of claim 6 further comprising an adhesive which secures the insert to the hole in the body.

8. The handle of claim 1 wherein the base comprises a first section and two side sections, each side section including one of two bases and the two side sections are spaced apart and connected to the first section, each base comprising the insert positioned in the hole of the base, the insert being metallic and the distal most portion of each insert is positioned flush or below the base, each insert comprising the female threaded portion and each having a central axis and the insert is mounted in the material, the central axis of a first one of the two side sections is substantially parallel the central axis of a second one of the two side sections.

9. The handle of claim 8 wherein the plys of the two side sections are arranged substantially parallel the respective central axis of that side section and plys of the first section are arranged transverse the plys of the two side sections.

10. The handle of claim 9 wherein the plys of the first section are substantially perpendicular the plys of the two side sections.

11. The handle of claim 9 wherein a proximal surface comprises portions of at least two of the plys which are at least three times wider than a thickness of the plys such that the proximal surface varies in color based on which of the plys is visible.

12. The handle of claim 8 wherein the plys of the two side sections and the plys of the first section are arranged substantially parallel to the axis.

13. The handle of claim 12 wherein the plys are arranged longitudinally along the first section.

14. The handle of claim 13 wherein a side surface of the first section is positioned on either side of a proximal surface of the first section and the side surface comprises portions of at least two of the plys which are at least three times wider than a thickness of the plys such that the side surface varies in color longitudinally based on which of the plys is visible.

15. A handle comprising:
a body comprising a material which is a multi ply resin impregnated wood, the body has a proximal end and a distal end, the distal end comprising a base;
an insert positioned in a blind hole of the base, wherein the insert is made of a second material different from the material and a distal most portion of the insert is positioned flush or below the base, the insert comprising a female threaded portion having a central axis and the insert is mounted in the material and the proximal end of the body excludes one or more through holes;
wherein the body is symmetrical about the axis and includes one or more sections which include a circular cross section taken across the axis and a side profile of the body varies in width measured through the axis between the proximal and distal ends;
wherein all of the plys are arranged substantially parallel to the axis such that a side surface of the body includes portions where the plys are seen substantially vertically arranged along the axis and another side where plys create a variable shaped pattern;
wherein the handle is configured to be mounted with the base flush against another part such that the insert is not visible.

16. The handle of claim 15 wherein the insert comprises only a single insert and the insert includes exterior threads which interact with female threads in the hole of the body, wherein the threads are in the material.

17. The handle of claim 15 wherein the insert is metallic.

18. The handle of claim 15 wherein the body is symmetrical about an axis of the blind hole.

19. The handle of claim 15 wherein at least three of the plys are dyed different colors and are arranged in a repeating pattern and the plys are approximately ⅛ inches thick or less.

20. The handle of claim 15 wherein the handle is configured to be mounted such that only the material and any finishes thereon are visible.

21. The handle of claim 15 wherein at least two of the plys are dyed different colors and are arranged in a pattern within the body.

22. The handle of claim 21 wherein at least three of the plys are dyed different colors and are arranged in the body in a repeating pattern.
